(19) United States
(12) Patent Application Publication
(10) Pub. No.: US 2020/0086671 A1
(43) Pub. Date: Mar. 19, 2020

(54) Notebook With Replaceable Paper Sections

(71) Applicant: Victor L. Marks, Vancouver (CA)

(72) Inventor: Victor L. Marks, Vancouver (CA)

(21) Appl. No.: 16/573,836

(22) Filed: Sep. 17, 2019

Related U.S. Application Data
(60) Provisional application No. 62/732,489, filed on Sep. 17, 2018.

(51) Int. Cl. B42D 1/06; B42D 5/02; B42F 13/00; B42D 1/00

(52) U.S. Cl. CPC B42D 1/06; B42D 5/02; B42P 2241/02; B42D 1/001; B42F 13/0073

(57) ABSTRACT

A notebook with replaceable sections comprises a cover having a front portion, a rear portion, and a spine portion joining the front portion and the rear portion. There is a connector member extending along the spine portion of the cover. A plurality of longitudinally extending recesses is formed in the connector member. The notebook further includes a plurality of paper sections. Each of the paper sections being bound together at one end by an elongate connector. Each of the longitudinally extending recesses receives the elongate connector of one of the paper sections to releasably attach one of the paper sections to the cover.

### RELATED APPLICATIONS

This application claims priority to U.S. Provisional Application Ser. No. 62/732,489 filed Sep. 17, 2018 entitled Notebook With Replaceable Paper Sections, which is hereby incorporated herein by reference in its entirety.

### TECHNICAL FIELD

The present disclosure relates to a notebook and, in particular, to a notebook with replaceable paper sections.

### BACKGROUND

German Patent Application Publication No. 10 2011 101 463, which was published in the name of Zeller on Nov. 24, 2011, discloses a system having interchangeable note-paper stacks. The system comprises a cover with a back portion and two cover parts. The cover is provided with an inner cover sheet on an inner side thereof. The back portion of the cover sheet is provided with a reinforcement part, i.e. folding part, at lower and upper ends. The reinforcement part forms a carrier for a fixation system together with the back portion. The fixation system comprises a fixation tape encircling the carrier, where the fixation tape is made of an elastic band or elastic cord. An outer side of the cover is decorated with a coating.

PCT International Publication No. WO 2017/014352, which was published in the name of Park on Jan. 26, 2017, discloses a notebook system where the inner paper is replaceable. The system has pockets inside the cover in various directions and enables the wing of the inner paper to be inserted in a direction desired by a user such that the writing direction or position can be freely changed according to the intention of the user.

PCT International Publication No. WO 2011/041564, which was published on Apr. 7, 2011 in the name of El-Sorrogy, discloses a book block and/or set of printed matter contemplated to be bound in individual sections through various techniques. These sections are unbound or stitched to section covers or glued to section covers. These sections are then augmented with attachment members to allow sections to be secured to each other or a book cover. These attachment members may be secured to the sections in a permanent or non-permanent manner, including tension and/or clamping and/or crimping and/or sewing/stitching and/or gluing. The user of the book can then select and detach individual sections of the book block or set of printed matter without destroying the integrity of the entire book block or set of printed matter. Likewise, publishers of the book are able to update and/or replace sections of an entire book block and/or printed matter without needing to reprint and republish the whole book or set of printed matter.

### SUMMARY

There is provided a notebook comprising a cover having a front portion, a rear portion, and a spine portion joining the front portion and the rear portion. There is a plurality of elongate first connectors extending longitudinally along the spine portion of the cover. There is also a plurality of paper sections. Each of the paper sections is bound together at one end by an elongate second connector. Each of the elongate first connectors receives the elongate second connector of one of the paper sections to releasably attach one of the paper sections to the cover.

Each of the elongate first connectors may slidingly receive the elongate second connector of one of the paper sections. The elongate first connectors may extend parallel to each other and along the entire length of the spine portion of the cover. Each of the elongate second connectors may extend along the entire length of one end of its respective paper section. Each of the elongate first connectors may include an enlarged projection and each of the elongate second connectors may include a recess which receives the enlarged projection. The enlarged projection and the recess may have complementary shapes. The recess may have a mouth that is narrower than the enlarged projection.

There is also provided a notebook comprising a cover having a front portion, a rear portion, and a spine portion joining the front portion and the rear portion. There is a connector member extending along the spine portion of the cover. A plurality of longitudinally extending recesses is formed in the connector member. The notebook further includes a plurality of paper sections. Each of the paper sections is bound together at one end by an elongate connector. Each of the longitudinally extending recesses receives the elongate connector of one of the paper sections to releasably attach one of the paper sections to the cover.

Each of the longitudinally extending recesses may slidingly receive the elongate connector of one of the paper sections. The longitudinally extending recesses may extend parallel to each other and along the entire length of the spine portion of the cover. Each of the elongate connectors may extend along the entire length of one end of its respective paper section.

The elongate connectors and the longitudinally extending recesses may have complementary shapes. Each of the elongate connectors may include an enlarged projection. The enlarged projection may be larger than a mouth of each of the longitudinally extending recesses. The spine portion of the cover may be outwardly curved and the connector member may have a curved bottom.

### BRIEF DESCRIPTION OF THE DRAWINGS

FIG. 1 is a perspective view of a first embodiment of a notebook with replaceable paper sections;

FIG. 2 is an elevational view of the notebook of FIG. 1;

FIG. 3 is an enlarged end view of a portion of the notebook of FIGS. 2;

FIG. 4 is a perspective view of the notebook of FIG. 1 with the paper sections removed;

FIG. 5 is a perspective view of one of the paper sections of the notebook of FIG. 1;

FIG. 6 is another perspective view of the notebook of FIG. 1 showing one of the paper sections being inserted into the notebook;

FIG. 7 is an enlarged end view of a portion of the notebook of FIG. 1 showing pages of the notebook open;

FIG. 8 is a perspective view of a second embodiment of a notebook with replaceable paper sections;

FIG. 9 is an elevational view of the notebook of FIG. 8;

FIG. 10 is an enlarged end view of a portion of the notebook of FIG. 9;

FIG. 11 is a perspective view of the notebook of FIG. 8 with the paper sections removed;

FIG. 12 is a perspective view of one of the paper sections of the notebook of FIG. 8;

FIG. 13 is another perspective view of the notebook of FIG. 8 showing one of the paper sections being inserted into the notebook;

FIG. 14 is a perspective view of a third embodiment of a notebook with replaceable paper sections;

FIG. 15 is an elevational view of the notebook of FIG. 14;

FIG. 16 is an enlarged end view of a portion of the notebook of FIGS. 15;

FIG. 17 is a perspective view of the notebook of FIG. 14 with the paper sections removed;

FIG. 18 is a perspective view of a connector member of the notebook of FIG. 14;

FIG. 19 is a cross-sectional view of the connector member taken along line 19-19 of FIG. 18;

FIG. 20 is a perspective view of one of the paper sections of the notebook of FIG. 14;

FIG. 21 is a perspective view of a binding member of the notebook of FIG. 14; and

FIG. 22 is a cross-sectional view of the binding member taken along line 22-22 of FIG. 21.

### DESCRIPTION OF SPECIFIC EMBODIMENTS

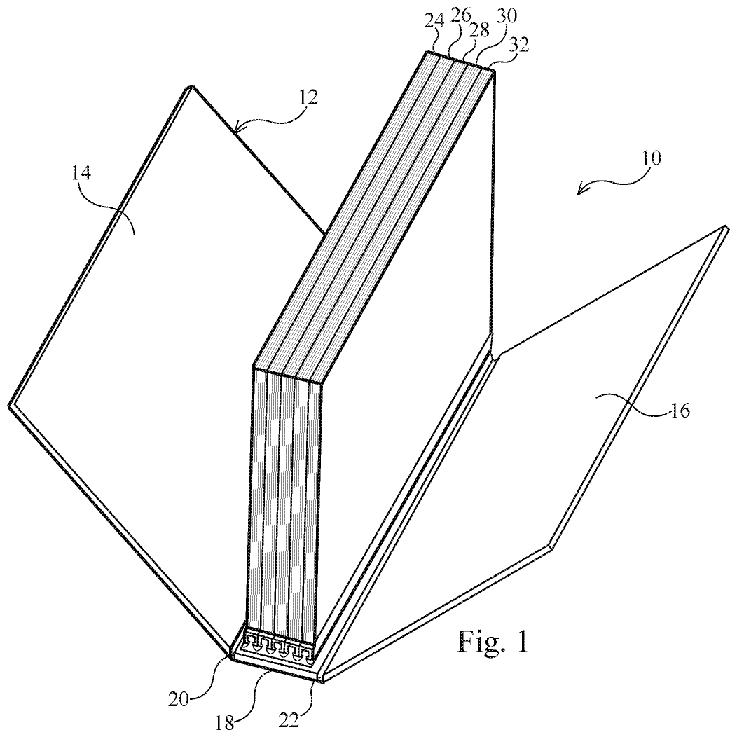

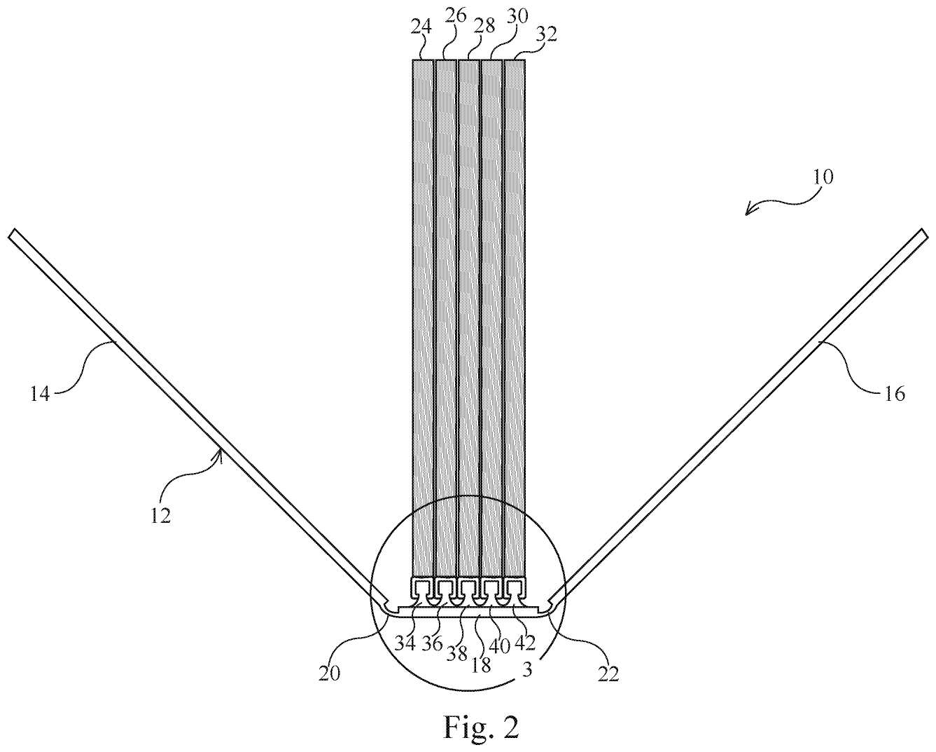

Referring to the drawings and first to FIG. 1, there is shown a first embodiment of a stationery item which in this example is a notebook 10. The notebook 10 includes a cover 12 having a front portion 14, a rear portion 16 and a spine portion 18. The spine portion 18 is connected to the front portion 14 and the rear portion 16 by two hinges 20 and 22 extending along opposite longitudinal sides of the spine portion 18. The hinges 20 and 22 may be formed, for example, as two thinned lines in the cover 12 as shown in FIG. 2. The notebook 10 also includes a plurality of paper sections as shown by paper sections 24, 26, 28, 30 and 32. It will however be understood by a person skilled in the art that the notebook 10 may include any suitable number of paper sections. The cover 12 may be made of a rigid or flexible material. The cover 12 may have an outer covering of leather, textile, paper or other material.

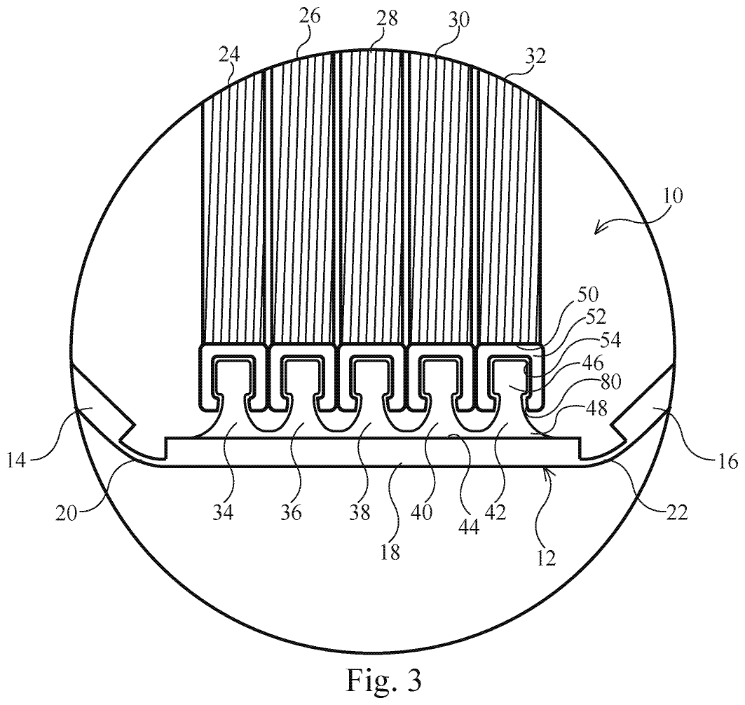

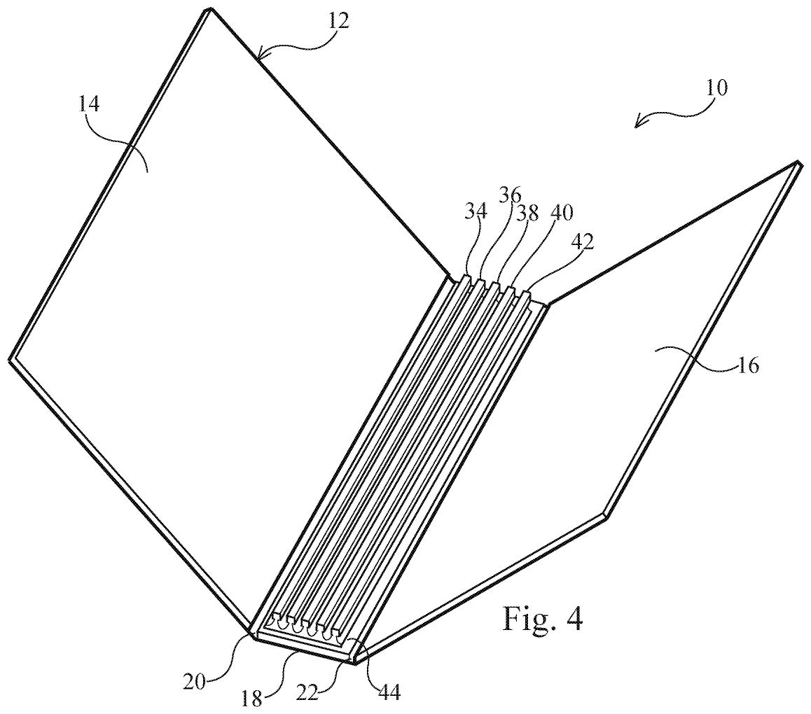

There is a plurality of elongate first connectors 34, 36, 38, 40 and 42 extending longitudinally along an interior 44 of the spine portion 18 of the cover 12 as best shown in FIG. 4. The elongate first connectors 34, 36, 38, 40 and 42 extend substantially parallel to each other and along substantially the entire length of the spine portion 18 in this example. The number of elongate first connectors may vary in other examples. The elongate first connectors 34, 36, 38, 40 and 42 are substantially the same in structure and function. Accordingly, only the elongate first connector 42 is described in detail herein with the understanding that the elongate first connectors 34, 36, 38 and 40 have substantially the same structure and function in substantially the same manner. The elongate first connector 42 is an elongate male connector in this example, and comprises an enlarged projection 46 and a base portion 48 as best shown in FIG. 3. In this example, the enlarged projection 46 has a rectangular cross section and the base portion 48 is flared.

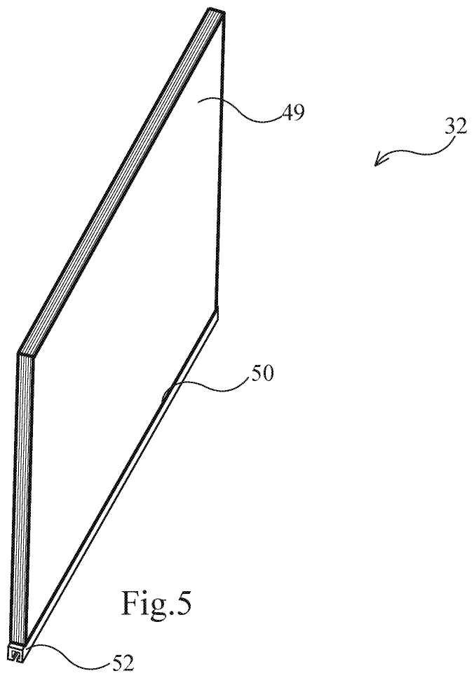

Each of the paper sections 24, 26, 28, 30 and 32 comprises sheets of paper bound together at one end by an elongate binding member as shown in FIG. 5 by sheets 49 bound together at one end 50 by an elongate binding member 52 for the paper section 32. The binding member 52 extends along substantially the entire length of the end 50 of the paper section 32 in this example. Referring back to FIG. 3, the binding member 52 has a rectangular cross section in this example with a recess or channel 54 which is complementary in shape to the rectangular enlarged projection 46 of the elongate first connector 42. The binding member 52 accordingly functions as an elongate second, or female, connector.

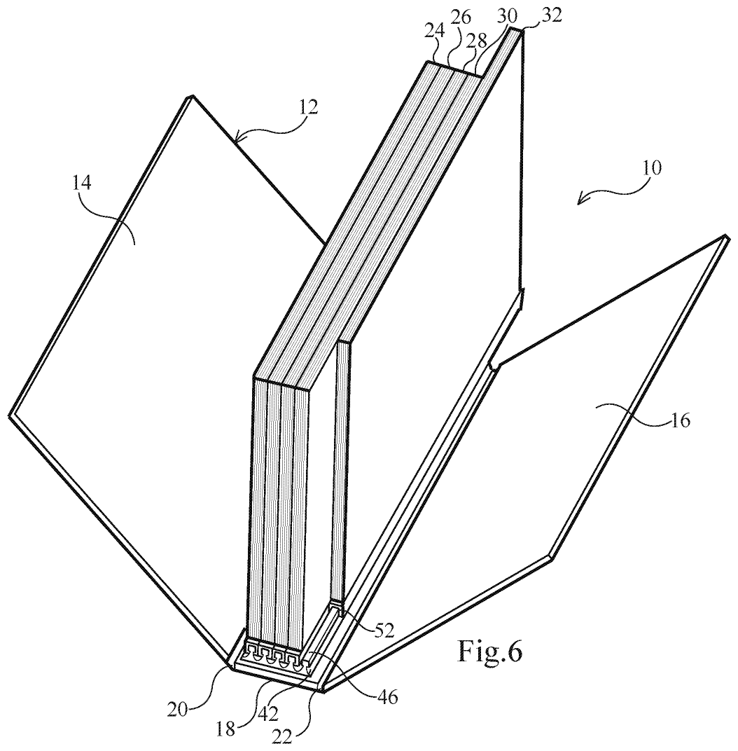

Specifically, the channel 54 of the binding member 52 slidingly receives the rectangular enlarged projection 46 of the elongate first connector 42 to allow the paper section 32 to be releasably attached to the spine portion 18 of the cover 12 as shown in FIG. 6. The paper section 32 is securely attached to the cover 12 in this way since the binding member 52 extends along substantially the entire length of the end 50 of the paper section 32 and the elongate first connector 42 extends along substantially the entire length of the spine portion 18 of the cover 12. Furthermore, the binding member 52 has a mouth 80 which is narrower than the enlarged projection 46 of the first connector 42, thereby restricting inadvertent detachment of the paper section 32 from the cover 12.

The paper sections 24, 26, 28 and 30 have substantially the same structure as the paper section 32 described above and therefore are not described in detail herein. It will be understood by a person skilled in the art that the paper sections 24, 26, 28 and 30 are each releasably attached to the spine portion 18 of the cover 12 via a corresponding one of the elongate first connectors 34, 36, 38 and 40 in substantially the same manner as described above for the paper section 32 and the elongate first connector 42.

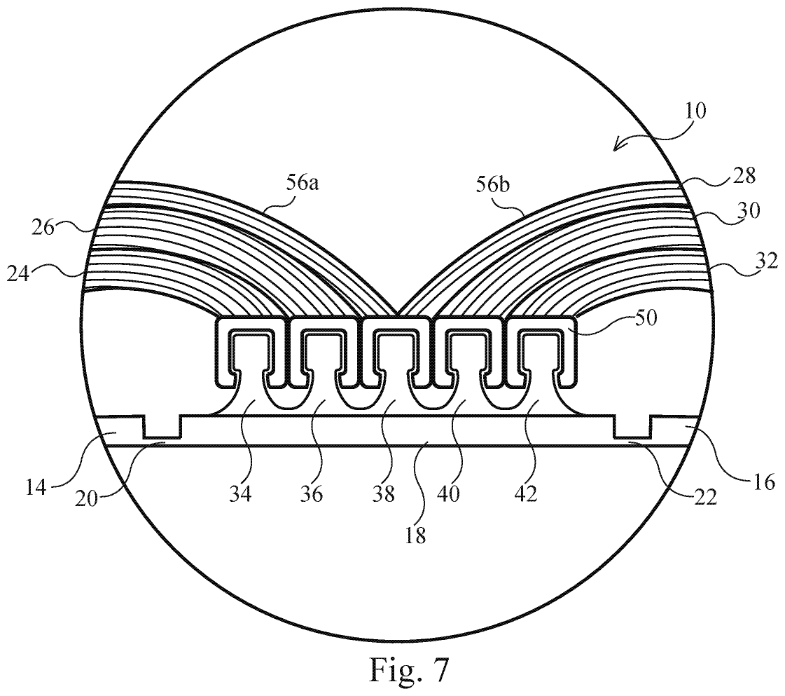

FIG. 7 shows the notebook 10 with its pages open. The binding members allow pages of the respective paper sections to lay substantially flat when open as shown by pages 56a and 56b of the paper section 28. This makes it easier for a user to write on the pages of the paper sections. Once the pages of a paper section are used up, the paper section can be detached from the notebook 10 and replaced with a blank paper section. Different paper sections can also be interchanged as desired to suit the needs of a user. One or more of the elongate first connectors may also be left empty if the user does not wish to fill up the notebook entirely with paper sections.

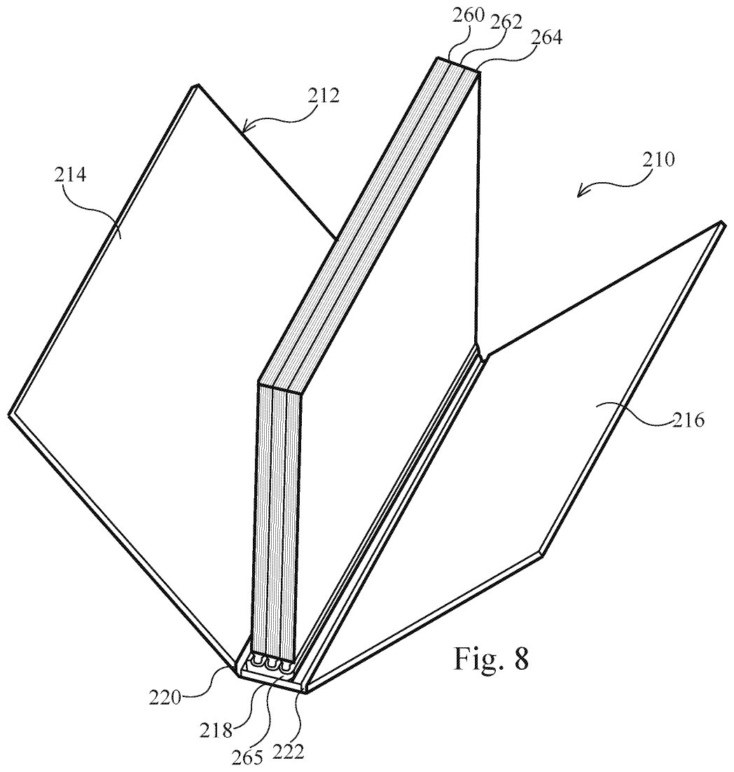

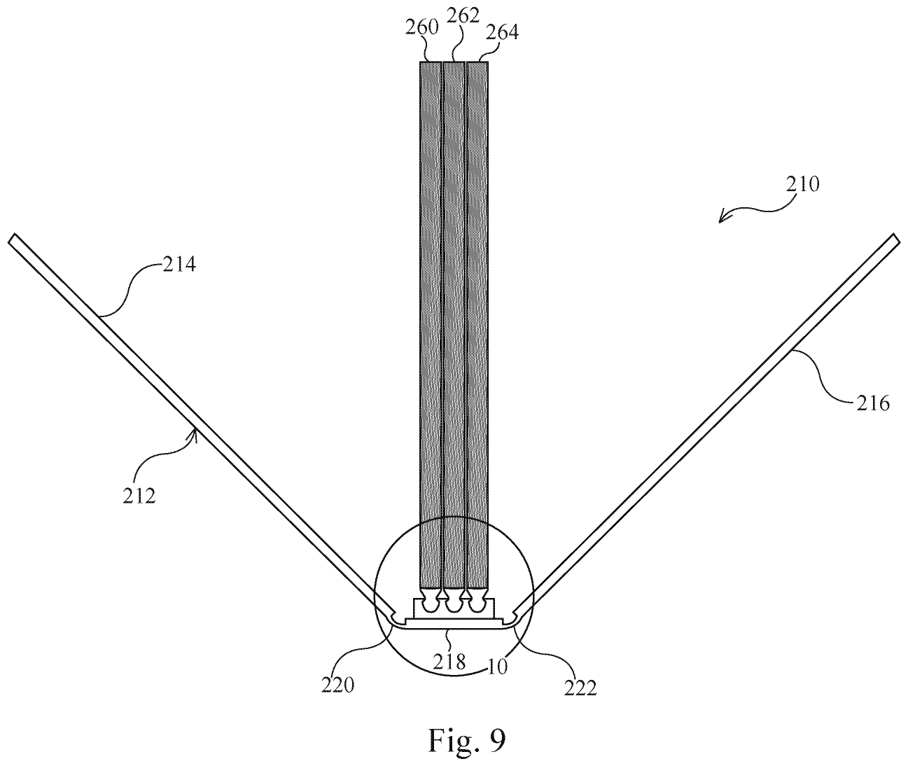

Referring now to FIGS. 8 to 13, there is shown a second embodiment of a stationery item which in this example is a notebook 210. Like parts have like numbers and functions as the notebook 10 described above and shown in FIGS. 1 to 7 with the added prefix “2”. The notebook 210 includes a cover 212 having a front portion 214, a rear portion 216 and a spine portion 218. The spine portion 218 is connected to the front portion 214 and the rear portion 216 by two hinges 220 and 222 extending along opposite longitudinal sides of the spine portion 218. The hinges 220 and 222 may be formed, for example, as two thinned lines in the cover 212 as shown in FIG. 9. The notebook 210 also includes a plurality of paper sections as shown by paper sections 260, 262 and 264.

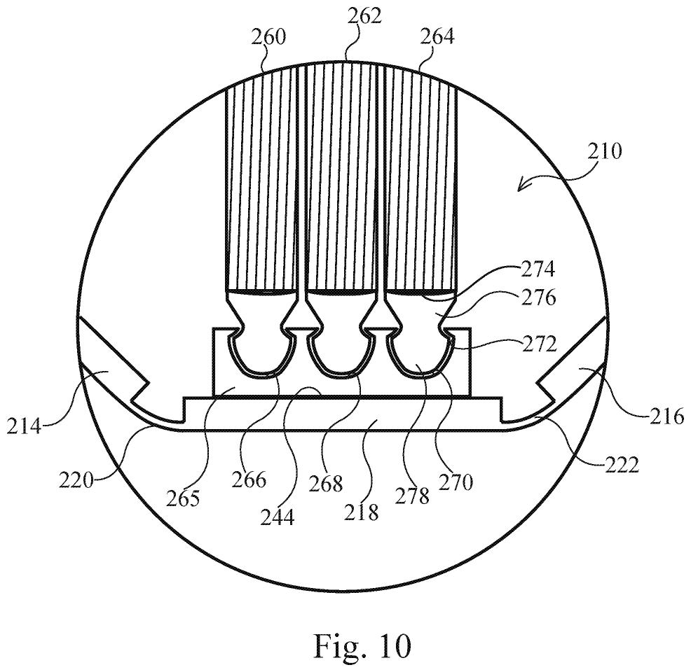

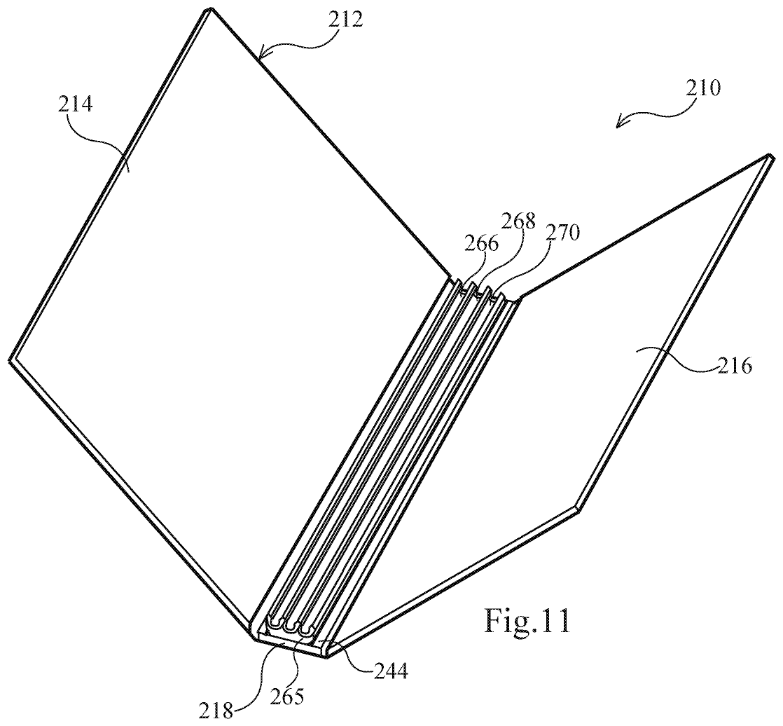

As shown in FIG. 11, there is a connector member 265 extending longitudinally along an interior 244 of the spine portion 218 of the cover 212. The connector member 265 extends along substantially the entire length of the spine portion 218 in this example. In this example, the connector member 265 has a substantially rectangular shape and a plurality of longitudinally extending recesses, for example, recesses 266, 268 and 270. The recesses 266, 268 and 270 extend substantially parallel to each other and along substantially the entire length of the connector member 265 in this example. Referring to FIG. 10, each of the recesses 266, 268 and 270 in this example is substantially U-shaped in cross section with a narrowed neck as shown by narrowed neck 272 for the recess 270. The recesses 266, 268 and 270 function as elongate female connectors as described below.

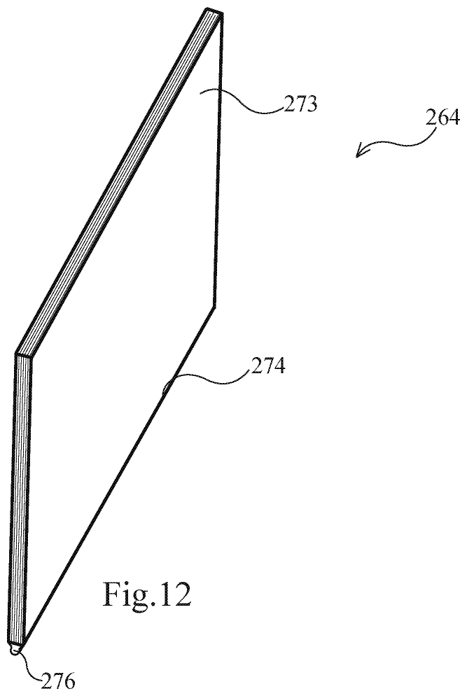

Each of the paper sections 260, 262 and 264 comprises sheets of paper bound together at one end by a binding member as shown in FIG. 12 by sheets 273 bound together at one end 274 by a binding member 276 for the paper section 264. The binding member 276 extends along substantially the entire length of the end 274 of the paper section 264 in this example. As best shown in FIG. 10, the binding member 276 terminates in an enlarged projection 278 which is rounded and complementary in shape to the recess 270. The binding member 276 accordingly functions as an elongate male connector cooperating with the recess 270.

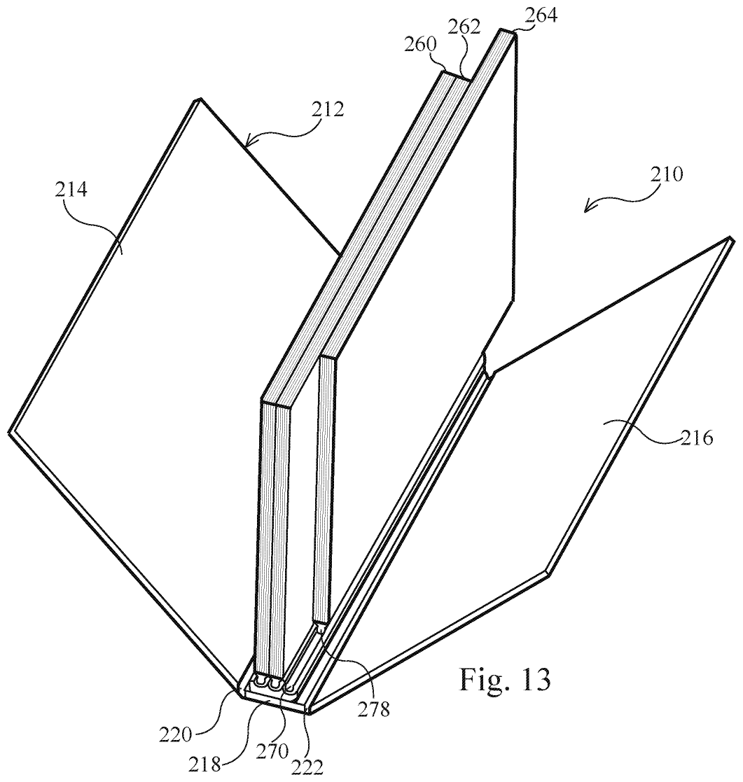

Specifically, the recess 270 slidingly receives the enlarged projection 278 of the binding member 276 to allow the paper section 264 to be releasably attached to the spine portion 218 of the cover 212 as shown in FIG. 13. The paper section 264 is securely attached to the cover 212 in this way since the binding member 276 extends along substantially the entire length of the end 274 of the paper section 264 and the recess 270 extends along substantially the entire length of the spine portion 218 of the cover 212. Furthermore, the narrowed neck 272 of the recess 270 is narrower than the enlarged projection 278 of the binding member 276, thereby restricting inadvertent detachment of the paper section 264 from the cover 212.

The paper sections 260 and 262 have substantially the same structure as the paper section 264 described above and therefore are not described in detail herein. It will be understood by a person skilled in the art that the paper sections 260 and 262 are each releasably attached to the spine portion 218 of the cover 212 via a respective binding member in substantially the same manner as described above for the binding member 276 of the paper section 264.

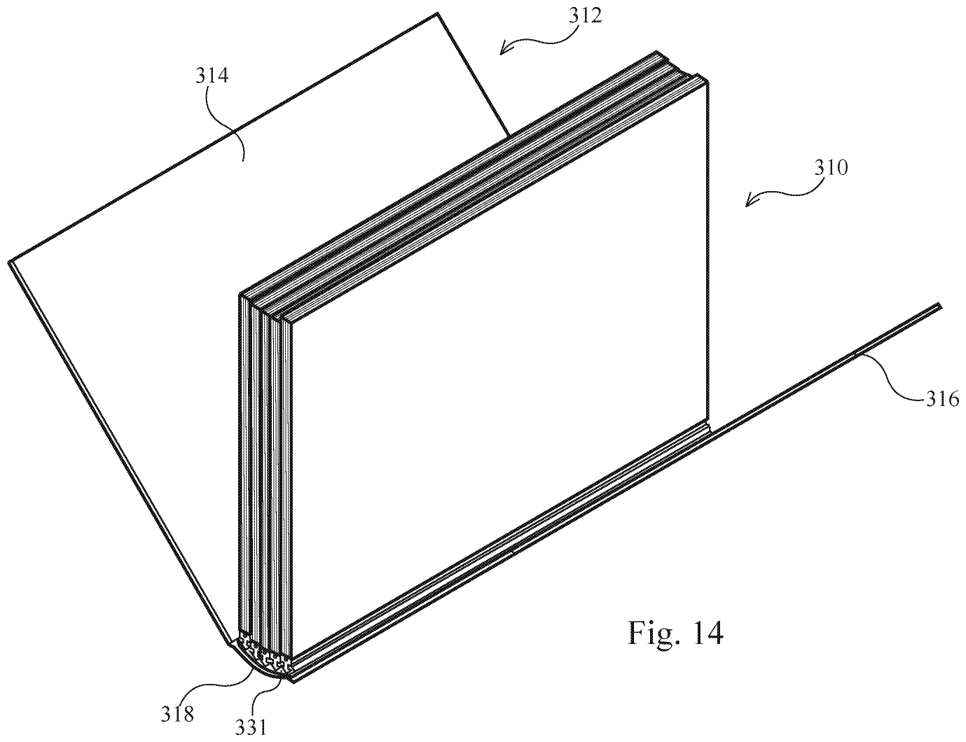

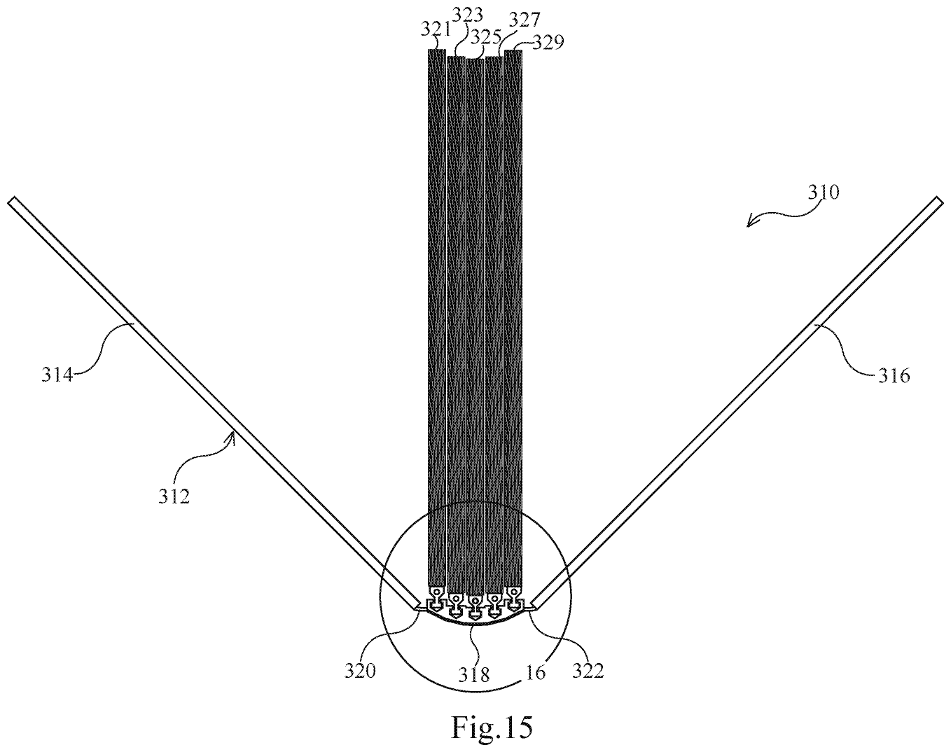

FIGS. 14 to 22 show a third embodiment of a stationery item which in this example is a notebook 310. Like parts have like numbers and functions as the notebook 10 described above and shown in FIGS. 1 to 7 with the added prefix “3”. The notebook 310 includes a cover 312 having a front portion 314, a rear portion 316 and a spine portion 318. The spine portion 318 is connected to the front portion 314 and the rear portion 316 by two hinges 320 and 322 extending along opposite longitudinal sides of the spine portion as best shown in FIG. 15. The hinges 320 and 322 may be formed, for example, as two thinned lines in the cover 312. The notebook 310 also includes a plurality of paper sections as shown by paper sections 321, 323, 325, 327 and 329.

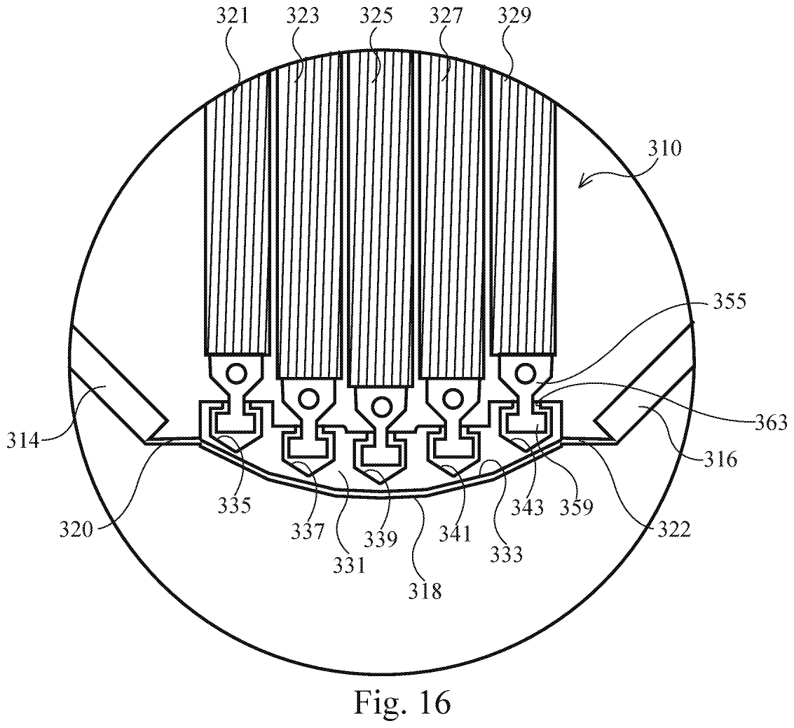

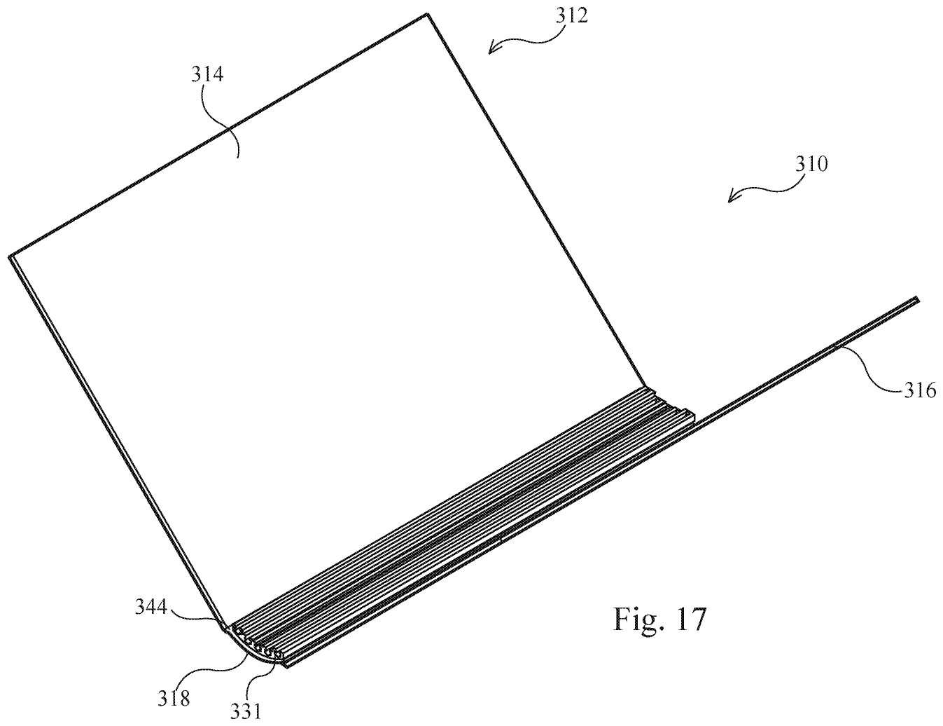

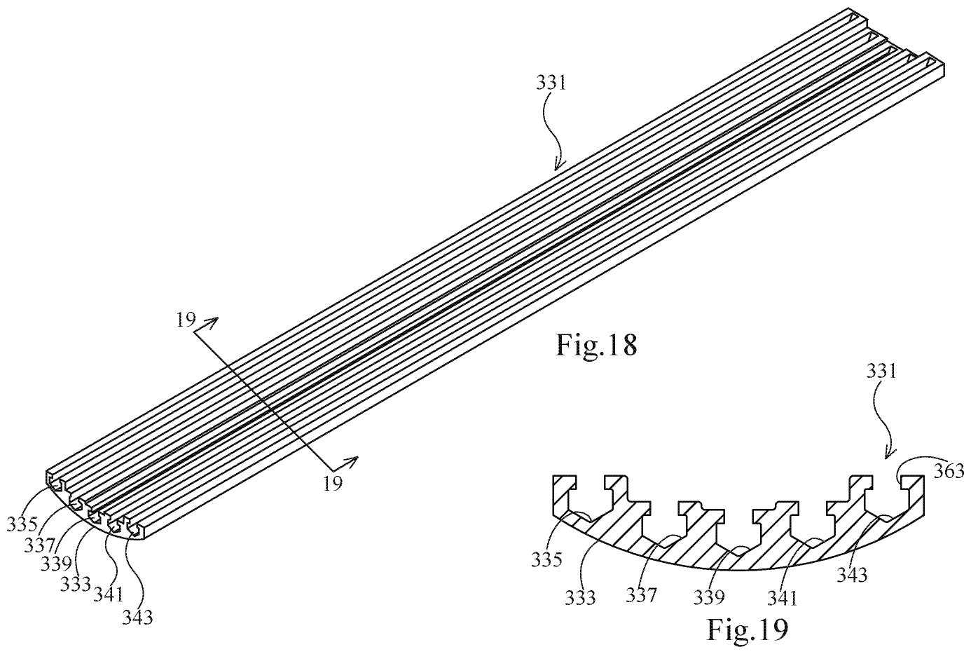

As shown in FIG. 17, there is a connector member 331 extending longitudinally along an interior 344 of the spine portion 318. The connector member 331 extends along substantially the entire length of the spine portion 318 in this example. The connector member 331 has a plurality of longitudinally extending recesses, for example, recesses 335, 337, 339, 341 and 343 best shown in FIG. 18. The recesses 335, 337, 339, 341 and 343 extend substantially parallel to each other and along substantially the entire length of the connector member 331 in this example. As best shown in FIG. 16, in this example, the spine portion 318 is outwardly curved in a convex manner and the connector member 331 has a complementarily shaped curved bottom 333. Each of the recesses 335, 337, 339, 341 and 343 has a general arrowhead shape in cross section in this example as best shown in FIG. 19. The recesses 335, 337, 339, 341 and 343 function as elongate female connectors as described below.

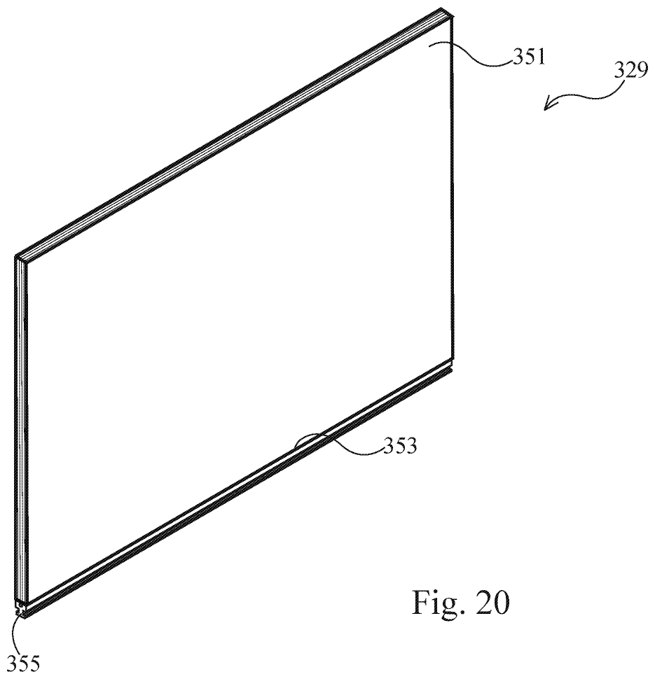

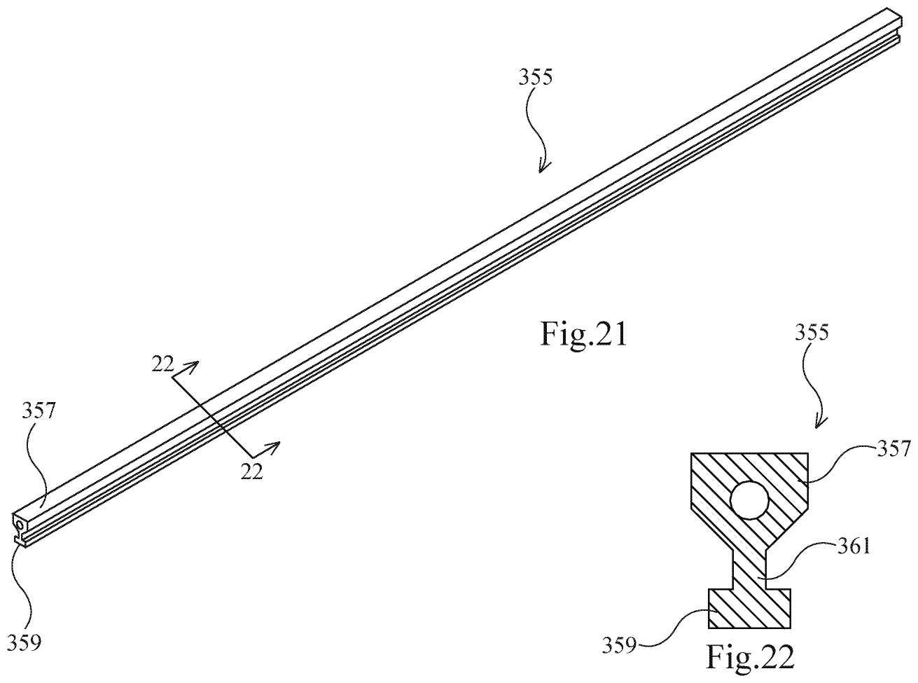

Each of the paper sections 321, 323, 325, 327 and 329 comprises sheets of paper bound together at one end by a binding member as shown in FIG. 20 by sheets 351 bound together at one end 353 by a binding member 355 for the paper section 329. The binding member 355 extends along substantially the entire length of the end 353 of the paper section 329 in this example. The binding member 355 is shown in greater detail in FIGS. 21 and 21, and includes a proximal portion 357 and a distal enlarged projection 359. In this example, the proximal portion 357 has a trapezoidal cross section and tapers towards a thin intermediate portion or web 361 joining it to the elongate projection 359. The elongate projection has a rectangular cross section in this example.

The elongate projection 359 functions as an elongate male connector cooperating with the recess 343 of the connector member 331 as best shown in FIG. 16. Specifically, the recess 343 slidingly receives the elongate projection 359 of the binding member 355 to allow the paper section 329 to be releasably attached to the spine portion 318 of the cover 312. The paper section 329 is securely attached to the cover 312 in this way since the binding member 355 extends along substantially the entire length of the end 353 of the paper section 329 and the recess 343 extends along substantially the entire length of the spine portion 318 of the cover 212. Furthermore, the recess 343 has a mouth 363 which is narrower than the enlarged projection 359 of the binding member 355, thereby restricting inadvertent detachment of the paper section 329 from the cover 312.

The paper sections 321, 323, 325 and 327 have substantially the same structure as the paper section 329 described above and therefore are not described in detail herein. It will be understood by a person skilled in the art that the paper sections 321, 323, 325 and 327 are each releasably attached to the spine portion 318 of the cover 312 via a respective binding member in substantially the same manner as described above for the binding member 355 of the paper section 329.

It will further be understood by a person skilled in the art that many of the details provided above are by way of example only, and are not intended to limit the scope of the invention which is to be determined with reference to the following claims.

What is claimed is:

1. A notebook comprising:
a cover having a front portion, a rear portion, and a spine portion joining the front portion and the rear portion;
a plurality of elongate first connectors extending longitudinally along the spine portion of the cover; and
a plurality of paper sections, each of the paper sections being bound together at one end by an elongate second connector;
wherein each of the elongate first connectors receives the elongate second connector of one of the paper sections to releasably attach said one of the paper sections to the cover.

2. The notebook of claim 1, wherein each of the elongate first connectors slidingly receives the elongate second connector of one of the paper sections.

3. The notebook of claim 1, wherein the elongate first connectors extend parallel to each other and along the entire length of the spine portion of the cover.

4. The notebook of claim 1, wherein each of the elongate second connectors extends along the entire length of said one end of its respective paper section.

5. The notebook of claim 1, wherein each of the elongate first connectors includes an enlarged projection and each of the elongate second connectors includes a recess which receives the enlarged projection.

6. The notebook of claim 5, wherein the enlarged projection and the recess have complementary shapes.

7. The notebook of claim 5, wherein the recess has a mouth that is narrower than the enlarged projection.

8. A notebook comprising:
a cover having a front portion, a rear portion, and a spine portion joining the front portion and the rear portion;
a connector member extending along the spine portion of the cover;
a plurality of longitudinally extending recesses formed in the connector member; and
a plurality of paper sections, each of the paper sections being bound together at one end by an elongate connector;
wherein each of the longitudinally extending recesses receives the elongate connector of one of the paper sections to releasably attach said one of the paper sections to the cover.

9. The notebook of claim 8, wherein each of the longitudinally extending recesses slidingly receives the elongate connector of one of the paper sections.

10. The notebook of claim 8, wherein the longitudinally extending recesses extend parallel to each other and along the entire length of the spine portion of the cover.

11. The notebook of claim 8, wherein each of the elongate connectors extends along the entire length of said one end of its respective paper section.

12. The notebook of claim 8, wherein the spine portion of the cover is outwardly curved and the connector member has a curved bottom.

13. The notebook of claim 8, wherein the elongate connectors and the longitudinally extending recesses have complementary shapes.

14. The notebook of claim 8, wherein each of the elongate connectors includes an enlarged projection, the enlarged projection being larger than a mouth of each of the longitudinally extending recesses.
